(19) United States
(12) Patent Application Publication
(10) Pub. No.: US 2024/0320978 A1
(43) Pub. Date: Sep. 26, 2024

(54) METHOD FOR MONITORING A LOADING SPACE

(71) Applicant: ZF CV SYSTEMS GLOBAL GMBH, Bern (CH)

(72) Inventors: Konrad FEYERABEND, Hannover (DE); Sebastian KUEHNE, Sarstedt (DE); Gafur ZYMERI, Ronnenberg (DE)

(21) Appl. No.: 18/579,513

(22) PCT Filed: Jun. 21, 2022
(86) PCT No.: PCT/EP2022/066859

§ 371 Date: Jan. 16, 2024

(30) Foreign Application Priority Data
Jul. 21, 2021 (DE) 10 2021 118 878.4

(51) Int. Cl. G06V 20/52; G01S 7/48; G01S 17/89; G06V 20/64

(52) U.S. Cl. CPC G06V 20/52; G01S 7/4802; G01S 17/89; G06V 20/64

(57) ABSTRACT

A method for monitoring a loading space, including measuring at least one surface bounding the loading space in three dimensions using one or more distance-measuring sensors and capturing actual distances of measurement points or sets of measurement points as measured values. The method further includes processing and classifying, by an algorithm programmed in a computing or analysis unit, 3D data associated with the measured values and comparing the 3D data with preset threshold values or patterns for an expected occurrence. The method further includes providing a signal when there is a preset deviation between actual and expected measured values. The one or more sensors capture, in a region of measurement points or sets of measurement points that represent expected distances from a three-dimensional door surface bounding the loading space, actual distances of measurement points. A “door open” or “door closed” state is recognized, and a corresponding signal is provided.

### CROSS REFERENCE TO RELATED APPLICATIONS

This application is a U.S. National Phase application under 35 U.S.C. § 371 of International Application No. PCT/EP2022/066859, filed on Jun. 21, 2022, and claims benefit to German Patent Application No. DE 10 2021 118 878.4, filed on Jul. 21, 2021. The International Application was published in German on Jan. 26, 2023 as WO 2023/001465 A1 under PCT Article 21(2).

### FIELD

The invention relates to a method for monitoring a loading space.

### BACKGROUND

A particular focus in loading-space monitoring is checking the door regions, in particular capturing the state of the doors of the loading space. Verifying whether or not the doors are closed is important, for example, for refrigerated transportation or for transporting sensitive goods or transporting animals etc. and not least also for preventing theft or unauthorized access to the load.

Conventional monitoring systems for doors, including doors of loading spaces, are known in the form of permanently installed systems, for instance magnetic switching contacts on the door, which can verify merely a binary state, namely can establish whether the door is closed or open. These systems cannot detect a certain opening angle of a door or the behavior of an opening over time. Moreover, such switching contacts are generally permanently fitted in the locking mechanism or in the lock and hence are permanently linked to the associated vehicle or container.

Furthermore, in such monitoring systems, every door or every door panel is equipped with corresponding contacts, which therefore have to be installed in an equally large number.

Systems are also known in the prior art that can recognize with the aid of sensors and associated computing and analysis units a loading status and also the state of loading-space doors.

In this regard, U.S. Pat. No. 7,940,955 B2 discloses a monocular wide-angle image verification system, which uses an algorithm (resident software routine) to perform boundary-value or boundary analysis on a digital image in a data processing apparatus (digital signal processor) after correcting for curvature, one of the purposes being to recognize the state of a door in terms of the “open” or “closed” states.

The images generated for this purpose by a camera are, however, two-dimensional representations of an intrinsically three-dimensional space, and are assessed, inter alia, by a brightness analysis of the individual color pixels. However, such a starting point in the form of two-dimensional images is not suitable for more extensive analyses nor for any conclusions about spatial, i.e. three-dimensional, properties of the space being viewed.

### SUMMARY

In an embodiment, the present disclosure provides a method for monitoring a loading space, comprising measuring at least one surface bounding the loading space in three dimensions using one or more distance-measuring sensors provided inside the loading space and capturing actual distances of measurement points or sets of measurement points as measured values by the one or more sensors. The method further comprises processing and classifying, by an algorithm programmed in a computing or analysis unit, 3D data associated with the measured values and comparing the 3D data associated with the measured values with preset threshold values or patterns for an expected occurrence of the measured values. The method further comprises providing a signal, which can be processed further, when there is a preset deviation between actual and expected measured values. The one or more sensors capture, in a region of measurement points or sets of measurement points that represent expected distances from a three-dimensional door surface bounding the loading space, actual distances of measurement points, which distances are described by 3D data, as measured values. In a case that the captured distances described by 3D data represent measurement points or sets of measurement points that describe three-dimensional surfaces outside the loading space, a “door open” state is recognized, and a corresponding first signal is provided, which can be processed further. In a case that the captured distances represent measurement points or sets of measurement points that do not describe three-dimensional surfaces outside the loading space, a “door closed” state is recognized, and a corresponding second signal is provided, which can be processed further.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a sketch of essential outlines of a loading space;

FIG. 2 illustrates a monitor display corresponding to reconditioned 3D data for a “door closed” case, which 3D data has been analyzed in accordance with a method according to an embodiment of the invention;

FIG. 3 illustrates a monitor display corresponding to reconditioned 3D data for a “door open” and “vehicle with loading space at ramp” case, which 3D data has been analyzed in accordance with a method according to an embodiment of the invention;

FIG. 3a illustrates in a sketch and purely qualitatively the principle behind the creation of the monitor image of FIG. 3;

FIG. 4 illustrates a monitor display corresponding to reconditioned 3D data for a “door open” and “vehicle with loading space not at ramp” case, which 3D data has been analyzed in accordance with a method according to an embodiment of the invention;

FIG. 4a illustrates in a sketch and purely qualitatively the principle behind the creation of the monitor image of FIG. 4;

FIG. 5 illustrates a monitor display corresponding to reconditioned 3D data for the case “left-hand door open” and “vehicle with loading space not at ramp”, which 3D data has been analyzed in accordance with a method according to an embodiment of the invention;

FIG. 6 illustrates a monitor display corresponding to reconditioned 3D data for the case “right-hand door open” and “vehicle with loading space not at ramp”, which 3D data has been analyzed in accordance with a method according to an embodiment of the invention; and

FIG. 7 illustrates by way of example different positions of sensors inside a loading space depicted only as a sketch.

### DETAILED DESCRIPTION

When “the sensor” or the “at least one sensor” is mentioned here and below, this sensor can be a single sensor but can also be one, several, or all of the plurality of sensors.

The term “expected measured values” here refers to those measured values that are characteristic of existing boundary surfaces of the loading space that are known from the geometry of the loading space. For example, given an installation or fixing location of the sensor inside the loading space, which location is likewise known and preset, the boundary surfaces of the loading space, i.e. floor, walls or roof, generate measured values or patterns of measured values, which can be uniquely assigned to these usual boundary surfaces of a loading space and hence define for all new measurements of the loading space the expected range for the then ascertained (new) measured values.

In an embodiment, the present invention provides improved loading-space monitoring, which uses a three-dimensional approach to deal with the actually present spatial circumstances, which in particular can recognize the status of the doors belonging to the loading space, and furthermore can provide a basis for further analyses and status-determinations by means of three-dimensional data.

In an embodiment, a method for monitoring a loading space is provided, in which method at least one surface bounding the loading space is measured in three dimensions using one or more distance-measuring sensors provided inside the loading space, wherein the actual distances from measurement points or sets of measurement points are captured by the sensor or sensors in the form of 3D data as measured values, and, by means of an algorithm programmed in a computing or analysis unit, the measured values are processed and compared with preset threshold values or patterns of an expected occurrence of the measured values and classified, and wherein a signal, which can be processed further, is provided when there is a preset deviation between actual and expected measured values or 3D data.

At least one distance-measuring sensor provided in the loading space captures, in the region of, or direction of, measurement points or sets of measurement points that represent the expected distances to the sensor from a three-dimensional door surface bounding the loading space, the actual respective distances of measurement points as measured values in the form of 3D data.

What is known as a depth-aware sensor is provided as the distance-measuring sensor, by means of which a three-dimensional measurement of measurement points, i.e. a measurement by distance and direction from the sensor, is possible, for example using corresponding spatial coordinates and a distance datum (3D data).

The algorithm programmed in the computing or analysis unit is designed such that, in the case that the captured distances represent measurement points or sets of measurement points that describe three-dimensional surfaces outside the loading space, the “door open” state is recognized, and a corresponding first signal is provided, which can be processed further.

In the alternative case in which the captured distances represent measurement points or sets of measurement points that do not describe three-dimensional surfaces outside the loading space, the algorithm recognizes the “door closed” state and provides a corresponding second signal, which can be processed further.

Thus the method according to an embodiment of the invention works with one or more depth-aware distance-measuring sensors, which are installed inside the loading space such that the entire loading space, or at least the regions of the loading space that are to be observed, lie in the measurement range of the sensor. Such sensors can be used to detect the load inside the loading space, and hence are also always mounted such that those surface regions of the loading space in which the doors are located likewise lie in the measurement range. Thus the measured values relating to the door regions can be used as depth information in order to determine the status of the doors more accurately. Of course the measured values exist here in the form of digital 3D data, which can also be combined to form suitable data sets, known as data clusters, for sets of measurement points for specific consideration, for instance into data clusters for the door region/doors.

The method according to an embodiment of the invention here uses the presence or absence of a set of measurement points of a surface outside the loading space, which measurement points are described by 3D data clusters. Expressed simply, the sensor “looks” towards the loading-space door and establishes whether it is possible to ascertain by 3D data a surface structure behind the door, i.e. outside the loading space.

An advantageous development comprises the algorithm being designed such that, in the case that the captured distances represent measurement points or sets of measurement points that describe three-dimensional surfaces outside the loading space, then the “door open” state is recognized if it is not possible to ascertain measurement points or sets of measurement points that represent the expected distances to the sensor from a three-dimensional door surface bounding the loading space, and that, in the alternative case that the captured distances represent measurement points or sets of measurement points that do not describe three-dimensional surfaces outside the loading space, then the “door closed” state is recognized if it is possible to ascertain at least some measurement points or some of a set of measurement points that represent the expected distances to the sensor from a three-dimensional door surface bounding the loading space.

Thus this additionally examines whether a further set of measurement points or further measurement points appear in the expected range, specifically those that describe a door surface that can actually be present. The presence or absence of the corresponding 3D data is then used as the basis for reverifying, or checking the plausibility of, the presence or absence of a three-dimensional surface lying outside the loading space. This achieves a very high level of certainty in the actual conclusion about the door state.

A further advantageous design comprises the algorithm being designed such that measurement points or sets of measurement points that represent the expected distances to the sensor from a three-dimensional door surface bounding the loading space are evaluated in relation to each other, wherein given a predetermined offset and distance of the measurement points with respect to each other and to the expected distance, an angled position of the bounding three-dimensional door surface is recognized, and an opening angle of the door is provided as a third signal, which can be processed further. Recognizing that a door of a loading space is just at an angle is important, for example, during loading and unloading of refrigerated goods from a refrigerated loading space. This can then avoid too long or too large an angled opening and hence a loss of energy.

A further advantageous design in monitoring a loading space belonging to a vehicle includes, in the case that the captured distances represent measurement points or sets of measurement points that describe three-dimensional surfaces outside the loading space which are at substantially the same height as the loading-space floor, the “door open” and “vehicle with loading space at loading ramp” state is recognized, and a corresponding fourth signal is provided, which can be processed further. It is evident that recognizing a loading-ramp position in conjunction with an open door is important for state recognition during the loading process, and can be used, for example, to prevent a vehicle starting up from this position until all the doors are closed.

The same applies to a further advantageous design, which includes, in the case that the captured distances represent measurement points or sets of measurement points that describe three-dimensional surfaces outside the loading space which are substantially below the height of the loading-space floor, the “door open” and “vehicle with loading space not at loading ramp” state is recognized, and a corresponding fifth signal is provided, which can be processed further. With suitably fast processing of the sensor signal, it is even possible here to give a warning or collision indication when driving up to a rear loading ramp.

A further advantageous design includes that the sensor captures only in portions of the expected distances of a three-dimensional door surface bounding the loading space the actual distances of measurement points as measured values, and in the case that the captured distances represent measurement points or sets of measurement points that describe three-dimensional surfaces outside the loading space, the “door open in parts” state is recognized, and a corresponding sixth signal is provided, which can be processed further. It is thereby possible to recognize openings for which only parts of a door are open, for instance the left-hand, right-hand, top, or bottom part of a door. In the case of trucks that have doors formed partly by a drivable loading ramp, it can be recognized, for example, whether a loading ramp is still closed but the top part of the door is already open, or vice versa.

A further advantageous design includes that the sensor is in the form of an optical depth sensor, preferably a time-of-flight camera (TOF camera) or stereo camera. For example, a TOF camera provides for each pixel the distance of the object imaged thereat. In this case, an entire scene can be acquired at once without having to scan individually, which of course leads to faster processing of the corresponding signals. Of course, depending on the usage, it is also advantageous if the sensor is in the form of a LiDAR sensor or laser scanner, which is a lower-cost alternative for raster scanning.

A further advantageous design includes that the change over time in the measured values characterizing the distances of measurement points or sets of measurement points is analyzed. With suitably fast processing of the signals, this can be used to track a chronological history or a course of events particularly well.

An apparatus for monitoring a loading space for implementing the method according to an embodiment of the invention is advantageously designed such that the apparatus has at least one distance-measuring sensor for three-dimensional measurement of at least one surface bounding a loading space, and a computing or analysis unit having a programmed algorithm, which is used to process in accordance with the method according to an embodiment of the invention the measured values captured by the sensor, wherein the sensor is located on a loading-space wall that bounds the loading space and has a door, i.e. is located on that surface bounding the loading space that also contains the door surface. Such a sensor position allows particularly good recognition of surfaces to be ascertained that lie outside the loading space. Additionally ascertaining the 3D data that represents measurement points or sets of measurement points of the door surface can then be achieved particularly well by a further advantageous design in which the sensor is located opposite a loading-space wall that bounds the loading space and has a door, i.e. is located on that surface bounding the loading space that is opposite the door surface.

Of course, a plurality of sensors can also be located on the one and the other of the loading-space walls mentioned. A corresponding comparative assessment and processing of the results from a plurality of sensors located at different sites in the loading space then also leads to even more accurate conclusions.

The method according to an embodiment of the invention and the apparatus which is particularly suitable therefor are especially suitable for a vehicle having a loading space, for instance for a truck, a trailer vehicle or a wagon train. Usage with containers being transported in other vehicles is also very possible. The vehicle or the container concerned have a loading space in which is provided at least one distance-measuring sensor for three-dimensional measuring of at least one surface bounding the loading space, wherein the vehicle or the container or the vehicle accommodating the container also have a computing or analysis unit having a programmed algorithm, which is used to process in accordance with the method according to embodiments of the invention the measured values captured by the sensor.

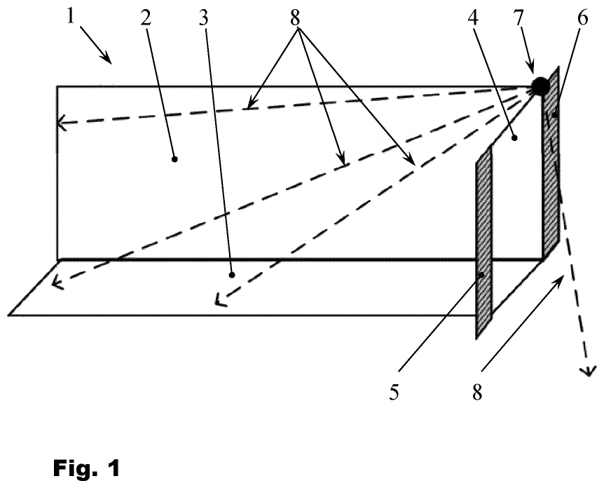

FIG. 1 shows a sketch of some essential outlines of a loading space 1 having a right-hand bounding wall 2, a loading-space floor 3 and a rear wall 4, which is depicted here with open doors 5, 6.

A distance-measuring sensor 7, here a TOF sensor, is located in the rear top corner of the loading space 1, which corner is formed by the right-hand bounding wall 2 and the rear wall 4. The dashed lines 8 represent by way of example some directions in which the sensor 7 can perform three-dimensional measurements.

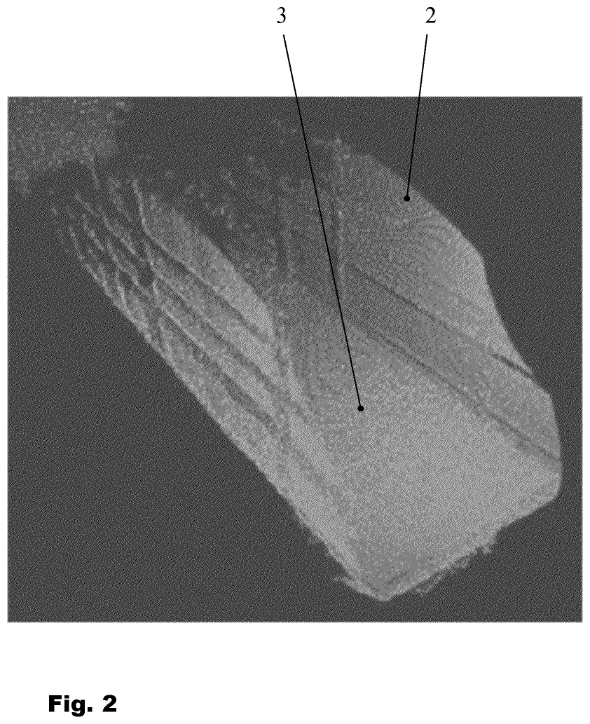

FIGS. 2 to 6 show monitor displays in which the signal generated by means of the method according to an embodiment of the invention, or the 3D data of said signal, has been processed for a visual display of the loading space. Suitable computational reconditioning of the 3D data then delivers the images shown here.

FIG. 2 shows a result of applying the method according to an embodiment of the invention, wherein the sensor 7, in the region of measurement points or sets of measurement points that represent the expected distances from a three-dimensional door surface bounding the loading space 1, has captured actual distances of measurement points as measured values and hence as 3D data. The algorithm on which the method according to an embodiment of the invention is based has identified using this data the case that the captured 3D data does not describe or represent three-dimensional surfaces outside the loading space 1, from which the “door closed” state is recognized.

Thus in this case, the analysis of the three-dimensional measurement by means of the sensor 7, in the processing by the algorithm, leads to the result that the doors are closed.

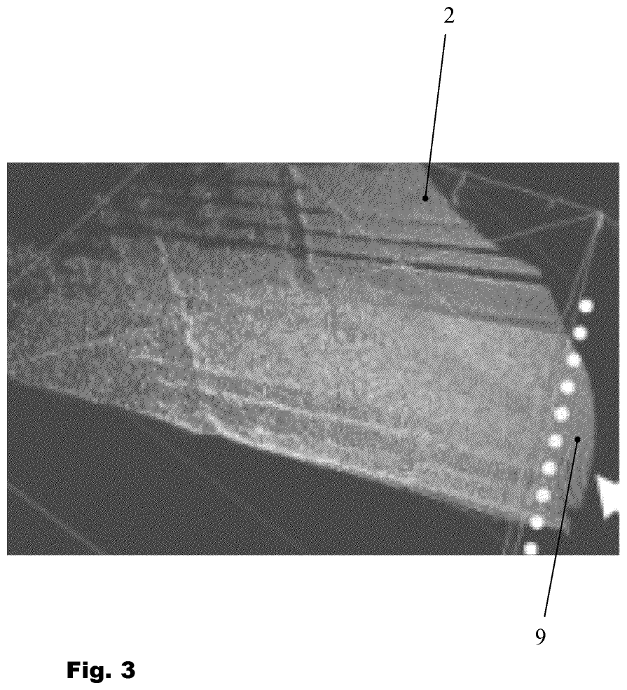

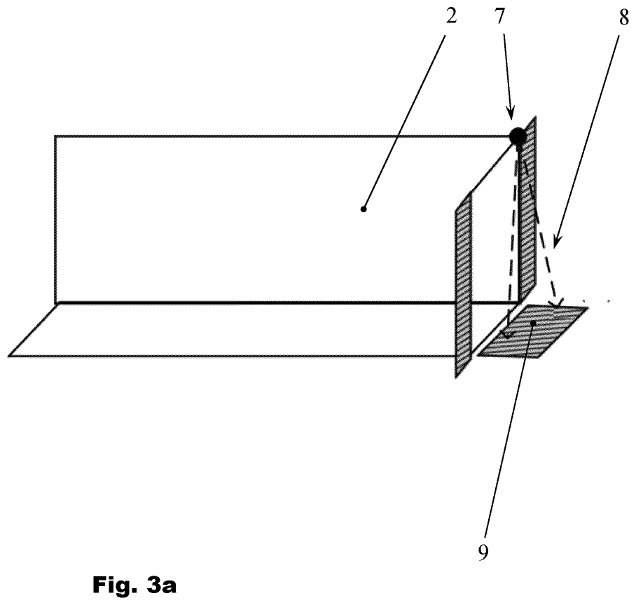

FIG. 3 shows a result of applying the method according to an embodiment of the invention in another case. Again in this case, actual distances of measurement points are first captured as measured values and hence as 3D data by the sensor 7 in the region of measurement points or sets of measurement points that represent the expected distances from a three-dimensional door surface bounding the loading space 1.

The algorithm on which the method according to an embodiment of the invention is based has now identified using the present 3D data the case that the captured 3D data describes a three-dimensional surface 9 outside the loading space 1. The dotted line in the monitor display of FIG. 3 here represents, for instance, a rear edge of the loading-space floor 3 of the loading space 1. For a clearer depiction, the perspective view has also been rotated slightly here counter-clockwise compared with FIG. 2.

Then, in accordance with the method, not only is the “door open” state recognized but it is also established that the three-dimensional surface 9 captured outside the loading space 1 lies at the same height as the loading-space floor 3. Consequently, in accordance with the logic of the method according to an embodiment of the invention, the “door open” and “vehicle with loading space at loading ramp” state is recognized.

FIG. 3a shows again in a sketch and purely qualitatively the principle behind the creation of the monitor image of FIG. 3. Similar to the sketch (FIG. 1) already presented above, a three-dimensional surface 9 outside the loading space 1 is visible here, which has arisen from applying the algorithm on which the method according to an embodiment of the invention is based for processing the captured 3D data from the sensor 7.

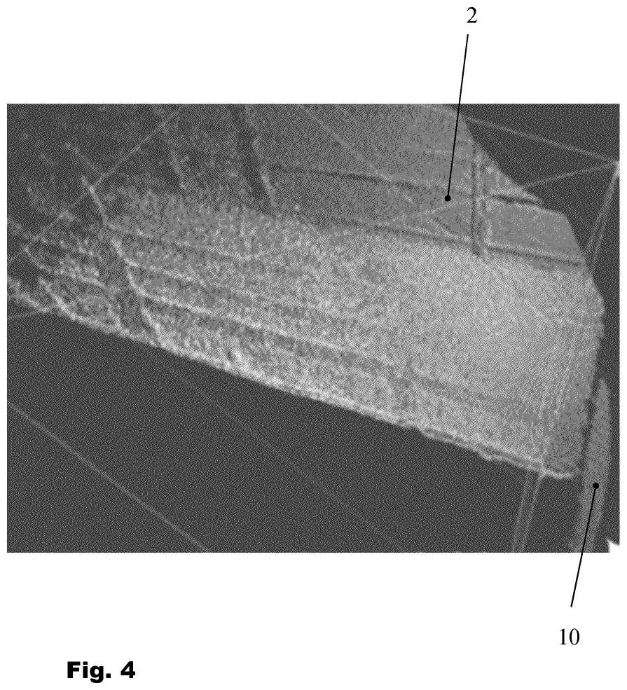

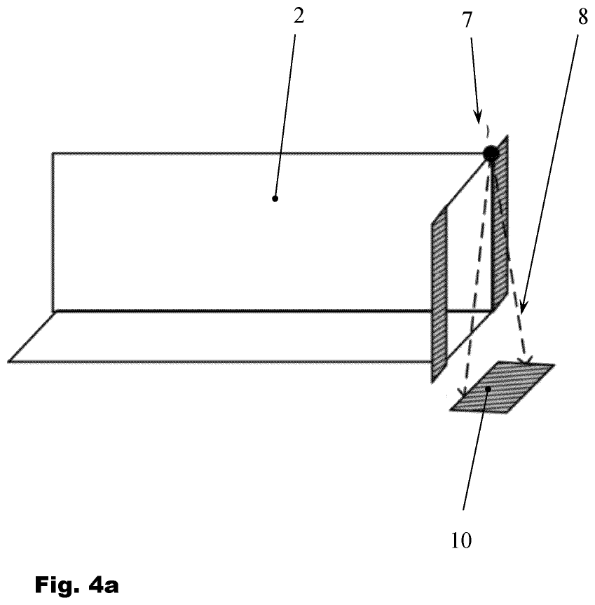

The circumstances in FIG. 4 are slightly different. Again here, the algorithm on which the method according to an embodiment of the invention is based has first identified using the present 3D data ascertained by the sensor 7 the case that the captured 3D data describes a three-dimensional surface 10 outside the loading space 1.

The three-dimensional surface 10 captured outside the loading space 1, however, does not lie at the same height as the loading-space floor 3. Consequently, in accordance with the logic of the method according to an embodiment of the invention, the “door open” and “vehicle with loading space not at loading ramp” state is recognized.

FIG. 4a shows in a sketch for the purpose of illustration and purely qualitatively, the principle behind the creation of the monitor image of FIG. 4. Similar to the sketch (FIG. 3a) already presented above, a three-dimensional surface 10 outside the loading space 1 is visible here, which lies below the height of the loading-space floor 3 and has arisen from applying the algorithm on which the method according to an embodiment of the invention is based.

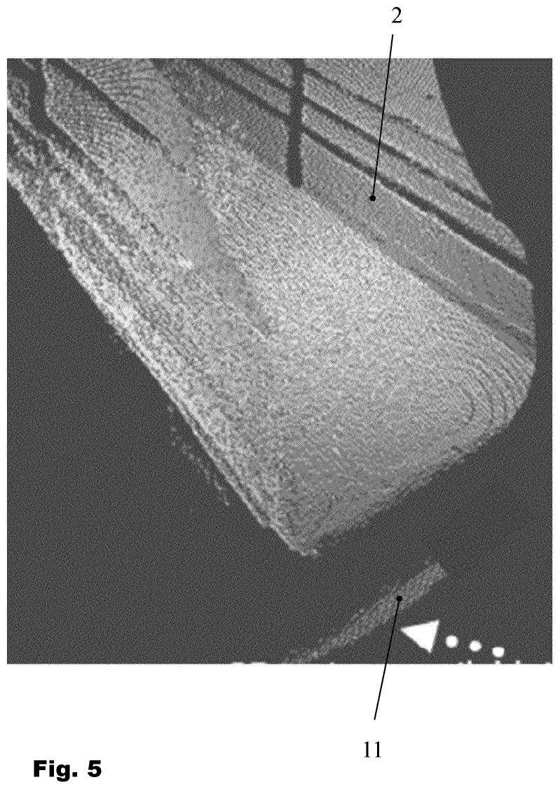

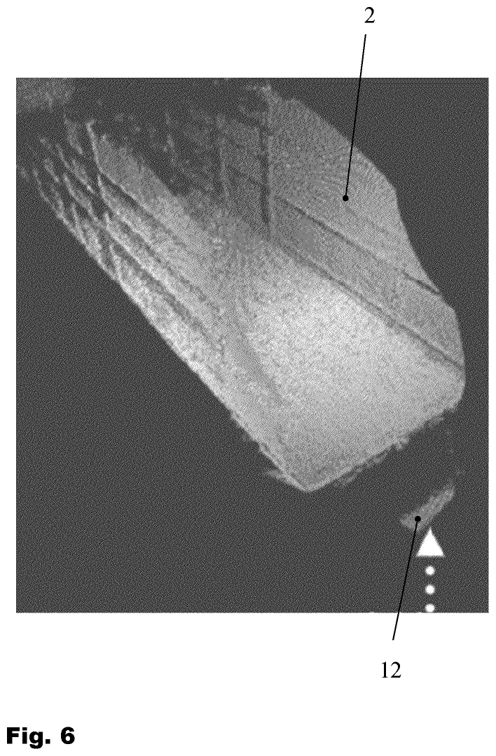

FIGS. 5 and 6 each show the case in which the algorithm on which the method according to an embodiment of the invention is based recognizes using the present 3D data ascertained by the sensor 7 “partly open doors” and “vehicle not at loading ramp”.

Again here, the sensor 7 captures in the expected distances of the measurement points from a three-dimensional door surface bounding the loading space 1 the actual distance of measurement points from the sensor 7 as measured values. The 3D data acquired for this purpose represents only in portions of the distances captured in the direction of the door surface, however, measurement points or sets of measurement points that describe three-dimensional surfaces 11 or 12 outside the loading space 1. Thus the “door open in parts” state is recognized in both cases, specifically the case “left-hand door open” corresponding to the monitor display of FIG. 5 and the case “right-hand door open” in the monitor display of FIG. 6. In both cases, the recognized three-dimensional surfaces are found to be located below the loading-space floor, and therefore the loading space cannot be standing at a loading ramp.

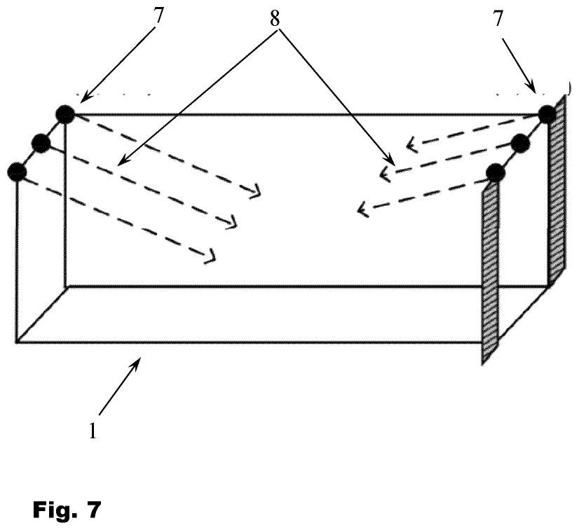

FIG. 7 shows again by way of example different positions of sensors 7 inside a loading space 1, shown only as a sketch, together with their respective main viewing directions.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

### Part of the Description

1 loading space
2 right-hand bounding wall of the loading space
3 floor of the loading space
4 rear wall of the loading space
5 door in the rear wall of the loading space
6 door in the rear wall of the loading space
7 TOF sensor
8 viewing directions of the sensor/measuring directions
9 three-dimensional surface outside the loading space
10 three-dimensional surface outside the loading space
11 three-dimensional surface outside the loading space
12 three-dimensional surface outside the loading space

1. A method for monitoring a loading space, comprising:
measuring at least one surface bounding the loading space in three dimensions using one or more distance-measuring sensors provided inside the loading space;
capturing actual distances of measurement points or sets of measurement points are captured as measured values by the one or more sensors;
processing and classifying, by an algorithm programmed in a computing or analysis unit, 3D data associated with the measured values and comparing the 3D data associated with the measured values with preset threshold values or patterns for an expected occurrence of the measured values;
providing a signal, which can be processed further, when there is a preset deviation between actual and expected measured values,
wherein the one or more sensors capture, in a region of measurement points or sets of measurement points that represent expected distances from a three-dimensional door surface bounding the loading space, actual distances of measurement points, which distances are described by 3D data, as measured values,
wherein in a case that the captured distances described by 3D data represent measurement points or sets of measurement points that describe three-dimensional surfaces outside the loading space, a “door open” state is recognized, and a corresponding first signal is provided, which can be processed further, and
wherein in a case that the captured distances represent measurement points or sets of measurement points that do not describe three-dimensional surfaces outside the loading space, a “door closed” state is recognized, and a corresponding second signal is provided, which can be processed further.

2. The method as claimed in claim 1, wherein the algorithm is configured such that:
in the case that the captured distances represent measurement points or sets of measurement points that describe three-dimensional surfaces outside the loading space, the “door open” state is recognized if it is not possible to ascertain measurement points or sets of measurement points that represent the expected distances to the one or more sensors from the three-dimensional door surface bounding the loading space, and
in the case that the captured distances represent measurement points or sets of measurement points that do not describe three-dimensional surfaces outside the loading space, the “door closed” state is recognized if it is possible to ascertain at least some measurement points or some of a set of measurement points that represent the expected distances to the one or more sensors from the three-dimensional door surface bounding the loading space.

3. The method as claimed in claim 1, wherein the algorithm is configured such that measurement points or sets of measurement points that represent the expected distances to the one or more sensors from the three-dimensional door surface bounding the loading space are evaluated in relation to each other, and
wherein given a predetermined offset and distance of the measurement points with respect to each other and to the expected distance, an angled position of the bounding three-dimensional door surface is recognized, and an opening angle of the door is provided as a third signal, which can be processed further.

4. The method as claimed in claim 1, wherein in the case that the captured distances represent measurement points or sets of measurement points that describe three-dimensional surfaces outside the loading space which are at substantially a same height as the loading-space floor, a “door open” and “vehicle with loading space at loading ramp” state is recognized, and a corresponding fourth signal is provided, which can be processed further.

5. The method as claimed in claim 1, wherein, in the case that the captured distances represent measurement points or sets of measurement points that describe three-dimensional surfaces outside the loading space which are substantially below a height of the loading-space floor, a “door open” and “vehicle with loading space not at loading ramp” state is recognized, and a corresponding fifth signal is provided, which can be processed further.

6. The method as claimed in claim 1, wherein the one or more sensors captures in the expected distances of the three-dimensional door surface bounding the loading space the actual distances of measurement points as measured values, and in the case that the captured distances represent measurement points or sets of measurement points that describe only portions of the expected distances three-dimensional surfaces outside the loading space, a “door open in parts” state is recognized, and a corresponding sixth signal is provided, which can be processed further.

7. The method as claimed in claim 1, wherein the one or more sensors are in the form of an optical depth sensor, preferably a time-of-flight camera or stereo camera.

8. The method as claimed in claim 1, wherein the one or more sensors are in the form of a LiDAR sensor or laser scanner.

9. The method as claimed in claim 1, further comprising analyzing a change over time in the measured values characterizing the distances of measurement points or sets of measurement points.

10. An apparatus for monitoring a loading space for implementing the method as claimed in claim 1, the apparatus comprising:
at least one distance-measuring sensor configured for three-dimensional measurement of at least one surface bounding a loading space; and
a computing or analysis unit having a programmed algorithm, which is and configured to process the measured values captured by the at least one sensor,
wherein the at least one sensor is located on a loading-space wall that bounds the loading space and has a door.

11. An apparatus for monitoring a loading space for implementing the method as claimed in claim 1, the apparatus comprising:
at least one distance-measuring sensor configured for three-dimensional measurement of at least one surface bounding a loading space; and
a computing or analysis unit having a programmed algorithm, which is and configured to process the measured values captured by the at least one sensor,
wherein the sensor is located opposite a loading-space wall that bounds the loading space and has a door.

12. A vehicle comprising:
a loading space;
at least one distance-measuring sensor provided inside a loading space and configured for three-dimensional measurement of at least one surface bounding the loading space; and
a computing or analysis unit having a programmed algorithm, which is configured to process in accordance with the method as claimed in claim 1 the measured values captured by the at least one sensor.
